(19) United States
(12) Patent Application Publication
(10) Pub. No.: US 2015/0039288 A1
(43) Pub. Date: Feb. 5, 2015

(54) INTEGRATED ORAL TRANSLATOR WITH INCORPORATED SPEAKER RECOGNITION

(71) Applicant: Joel Pedre, Saint Joseph (FR)

(72) Inventor: Joel Pedre, Saint Joseph (FR)

(21) Appl. No.: 13/824,693

(22) PCT Filed: Aug. 9, 2011
(86) PCT No.: PCT/FR2011/000463

§ 371 Date: Jun. 14, 2013

(30) Foreign Application Priority Data
Sep. 21, 2010 (FR) 10 03741

(51) Int. Cl. G06F 17/28; H04R 1/10

(52) U.S. Cl. CPC G06F 17/289; H04R 1/10
USPC 704/3

(57) ABSTRACT

A portable electronic translator (1) forming a headset. The translator (1) comprises at least: a sound pickup device (5) having firstly at least one mouth microphone (8) and at least one dialog microphone (9). The pickup device (5) is coupled to electronic means (11) in such a manner as to determine a current stage of conversation and to act automatically to adapt its functions as a function of that stage.

### CROSS REFERENCE TO RELATED APPLICATIONS

This application is the U.S. national phase of PCT Application No. PCT/FR2011/000463 which claims priority to French Application No. 10 03741 filed Sep. 21, 2010, the disclosures of which are incorporated in their entirety by reference herein.

### BACKGROUND OF THE INVENTION

(1) Field of the Invention

The invention relates to an oral (or voice) translator of the portable and self-contained type.

In particular, the invention relates to automatic translation enabling a first individual speaking in a first language to converse orally with a second individual speaking in a second language that is different from the first language.

(2) Description of Related Art

For this purpose, in a device referred to as an oral translator, translation means are provided between the first and second languages, a headset being connected to the translation means by connection means. The headset is provided with at least one earpiece, a microphone, and a loudspeaker situated on a mouth boom for supporting said microphone.

The microphone is arranged to pick up the speech of the individuals and then their speech is transmitted either to the earpiece or to the loudspeaker of the mouth boom. Thus, the person opposite the wearer of the translator can hear acoustically the speech translated from the speech uttered by the wearer as though that speech were issuing directly from the mouth of the wearer.

Such a translator is described in document FR 2 921 735 A1 or WO 2009/080908A1.

Potential improvements have appeared during the secret development of that translator, under the trade name “SpeakWorld®”.

These improvements relate firstly to interactivity, and to real effectiveness and ease of use of the translator. They also relate to the energy independence of such a translator.

Concerning that device, it is known that is crucial to guarantee long use and optimum availability for the translator. It is appropriate for the translator to be properly powered electrically at all times and for use of any duration.

This raises several problems; particularly since the power needed to enable such a translator to operate properly is not negligible, in particular because of the electrical power requirements of some of its components, in particular the loudspeakers on the month boom, given that they need to produce sufficient sound power to be heard clearly by the person opposite the wearer, at a distance therefrom, and in an environment that might be noisy.

In this context, batteries and rechargeable batteries capable of delivering such power are often found to be too bulky for lightweight and comfortable wearing of the translator. In addition, batteries are made using dangerous chemicals that are rare and difficult to recycle, which means that battery use in a translator should be limited.

Likewise, charging rechargeable batteries is often not very practical, since it requires the use of a dedicated charger that increases the amount of equipment the wearer needs to transport. It is also necessary to have an electricity outlet available. Under certain circumstances, and depending on the country, different nominal voltages can also make it necessary to transport an additional transformer. Furthermore, the time required for charging batteries from the mains (e.g. 220 V-50 Hz) can sometimes be long or even unacceptable for use of the translator.

Finally, with the forthcoming disappearance of fossil fuels, as a result of oil and uranium becoming rare, the cost of batteries and access to mains, both on initial purchase and during use, runs a major risk of also becoming an obstacle to widespread use of the translator.

That said, alternative proposals exist concerning supplying electrical power to portable electronic appliances such as a translator. Mention may be made of certain documents relating to this question.

Document US 2009/120429 describes a solar powered headset with an electronic element and a plurality of photovoltaic solar panels arranged in such a manner as to be capable of being moved between a closed position and an open position.

Document U.S. Pat. No. 6,101,256 describes a full protective helmet, e.g. for a firefighter or a motorcyclist. In order to connect the wearer of such a helmet with the outside from a sound point of view, the helmet is provided with a microphone and a loudspeaker, on the outside and on the inside. A signal coupler with an amplifier couples sound signals from an external microphone to the internal loudspeaker, or vice versa from our internal microphone to the external loudspeaker. A solar energy power supply may be provided.

Document US 2007/054705 describes a contactless appliance having multiple electrical power supply sources. A photovoltaic solar panel may be arranged on a loudspeaker shell of the appliance in the form of an audio headset. Releasable connections may also be provided on the shell. Connection by means of an optical cable is possible.

Document US 2005/282591 describes a hand-held mobile telephone with a radio receiver incorporated therein and photovoltaic solar panels on the top of a housing for a keypad and a screen.

Document WO 2009/132646 describes combining two audio signals coming from two microphones, in order to improve sound playback.

Beyond questions of energy independence, mention is made below of questions concerning “SpeakWorld®” type translators and improvements that could be made thereto concerning the interactivity, the ease of use, and the actual effectiveness in use of the translator.

These improvements seek to make it even more practical and agreeable, easy and effective to use. In patent matters, such improvements are typically referred to as solutions to various technical problems revealed by current (secret) developments and research.

In particular relating to the interactivity in use of such a translator, it can be understood that it is essential for it to be simple to use. Not only in order to make it easier for a new user to learn, but also so as to enable its user to concentrate on the ongoing conversation without having to worry or take action to inform the translator of the task that it is expected to perform. In particular, it can be understood that during a conversation that is to be translated, several distinct stages occur, namely:

utterance of speech by the wearer in the wearer's own language;

translation of said speech into the opposite language; and

the person opposite the wearer listening to said speech translated into that person's own language; and then:

the person opposite the wearer uttering other speech in reply in that person's own language that is not understandable by the wearer;

translating that non-understandable speech into the language of the wearer; and finally

the wearer listening to said speech translated into the wearer's own language.

From the above, it can be understood that it would be troublesome for the user to need to specify the present stage of the dialog in order to enable the translator to adapt its modes of operation during a conversation, e.g. by acting on touch-sensitive controls.

In addition, since the translator is in the form of an audio headset, it is not convenient for it to have such touch-sensitive controls. And voice recognition controls run the risk of interfering with the conversation.

Thus, ideally, it would be helpful if the translator were capable of determining automatically which is the current stage of a conversation and of acting independently (without human instruction) to adapt the ways in which it operates (receiving, translation, playing back, etc.) to match the current stage.

Furthermore, various practical aspects in the use of a translator could make it even more attractive. Thus, depending on circumstances, the functions and thus the hardware structures specific to such a translator may vary.

Conversely, in order to avoid making such a translator heavier and more complicated, it is possible to opt for a restricted selection of such hardware structures that are available on the translator, thereby putting a limit on the available functions.

Furthermore, it is common practice to possess one or more electronic appliances such as a personal computer, a personal digital assistant (PDA), a camera, a media player, etc.

It would thus sometimes be advantageous to be able to put such appliances into communication with the translator, e.g. in order to share resources (functions including data processing, power supply, display, etc.).

Finally, for transport and storage purposes, or indeed for presentation for sale or hire, and also for enabling it to be carried about, it is desirable for the translator to be suitable for housing in a container that is as compact and as practical as possible.

Mention may be made of various documents that are close to these topics. Thus, document U.S. Pat. No. 4,949,378 describes a toy in the form of a semi-complete protective helmet with a transparent visor. A microphone on a hinged boom is connected to the toy, and internal and external loudspeakers are provided, the external loudspeaker being situated at the top of the shell of the toy and serving to deliver unintelligible sounds. A button is provided to enable sound to be scrambled.

For reference, the following documents have been mentioned in the proceedings: US 2003/115059 which corresponds to WO 03/052624; U.S. Pat. No. 6,157,727; US 2006/282269; US 2004/186727; US 2008/091407; US 2006/282269; US 2008/077387; and WO 2009/132646.

### BRIEF SUMMARY OF THE INVENTION

The subject matter of the present invention is defined by the claims in order to propose an electronic translator that is usable with the help of the device of the invention in application of a determined method, making it possible to avoid the limitations of the above-mentioned translation devices by making conversation possible.

To this end, one embodiment of the invention provides a portable electronic translator forming a headset and comprising at least: a sound pickup device arranged on a front boom designed to place the pickup device facing a mouth position of a user. Said front boom being mounted on a main earpiece, itself secured to a headband or headset. The pickup device including firstly at least one mouth microphone arranged towards a posterior face of the front boom, and at least one dialog microphone arranged towards an anterior face of the front boom.

A sound playback device includes firstly at least one listening loudspeaker incorporated in said earpiece and a dialog microphone incorporated in the front boom so as to be oriented in a manner that is substantially similar to the orientation of the dialog microphone. Electronic and logic means being provided in the translator and arranged to pick up, process, playback, and translate speech.

In one embodiment, the pickup device is coupled to the electronic means; at least one dialog microphone is directed towards a speaker in a direction forming a conversation axis and has a front pickup field that is broad, whereas at least one mouth microphone is directed in an opposite direction, along the conversation axis, and has a rear field that is highly directional.

The electronic means possess discriminator means for discriminating a current conversation stage, including a stage of utterance by the wearer that implies translating into an opposite language when a signal from said mouth microphone is greater than another signal from the dialog microphone.

Under such circumstances, when an utterance stage of conversation has been determined, the electronic means proceed automatically to translation processing of said signal from said mouth microphone into an opposite language.

In an embodiment, the pickup device is arranged with the dialog microphone of the cardiod type, having a broad front pickup field.

In an embodiment, the pickup device is arranged with the mouth microphone of the hypercardiod or shotgun type, having a highly directional rear field.

In an embodiment, the electronic and logic means are provided at least in part in an earpiece of the translator and are arranged automatically to determine the following stages:

utterance of speech by the wearer in the wearer's own language;

translation of said speech into the opposite language;

the person opposite the wearer listening to said speech translated into that person's own language;

the person opposite the wearer uttering other speech in reply in that person's own language that is not understandable by the wearer;

translating that non-understandable speech into the language of the wearer; and

the wearer listening to said speech translated into the wearer's own language.

In an embodiment, the translator possesses at least one photovoltaic sensor.

In an embodiment, at least one photovoltaic sensor is on the headband of the translator.

In an embodiment, the translator possesses display means for displaying the delivery/listening state. These means are controlled by the electronic means so that a light of a determined color is activated as a function of the current stage of conversation, another color that is clearly distinct visually being provided for at least one other stage of conversation.

In an embodiment, the electronic means of the translator possess at least one connection for coupling to an external electronic appliance.

In an embodiment, the electronic means of the translator include transcription means that are incorporated in display means.

In an embodiment, the translator possesses a male connector plug, e.g. on a main earpiece, and/or a complementary female connector, e.g. on a boom.

The invention also provides a translation method making use of a translator as mentioned above.

According to the invention, the electronic means provide a function of switching language automatically, with it being determined automatically at all times, in real time and/or by repetitive intervals, which one of the wearer of the translator and the person opposite is the speaker who is speaking and which one is the speaker who is listening.

In an embodiment, the electronic means are arranged so that in a listening state, provision is made for signals coming from the pickup device of the mouth microphone type to be diminished and for playback of the other pickup device of the dialog microphone type to be increased, and/or for translation processing to be determined automatically, including selecting the language that is being produced and that is to be interpreted by the translator and selecting the language that is to be delivered via the playback device including the main earpiece.

### BRIEF DESCRIPTION OF THE SEVERAL VIEWS OF THE DRAWINGS

Various embodiments of the invention are described with reference to the accompanying figures, in which:

FIG. 1 is a diagram showing a conversation having recourse to a plurality of translators of the invention, each having display means for displaying its delivery/listening state;

FIG. 2 is a diagram showing a detail of an embodiment of a translator of the invention that possesses a so-called “unitary” form of the delivery/listening state viewing means, together with a removable branch for connecting by means of a male/female plug;

FIG. 3 is a diagrammatic view of a detail of an embodiment of a translator of the invention, coupled to an electronic appliance and/or a network that is connected via a logical connection;

FIG. 4 is a diagrammatic view showing a detail of an embodiment of a translator of the invention, with another form of removable branch, together with means for adjusting the size of a headband for at least one earpiece where means are situated for connecting and assembling said removable branch; and

FIG. 5 is a diagram showing a detail of an embodiment of a translator of the invention, with photovoltaic type electrical power supply means, e.g. arranged on a supporting headband.

### DETAILED DESCRIPTION OF THE INVENTION

That said, there follow descriptions of non-limiting embodiments of the invention.

In the figures, numerical reference 1 designates an electronic appliance constituting a portable voice translator. A wearer/user 2 wears the translator 10 on the head, in this example like a headset for listening to audio, whenever the user seeks to make use of the translator.

Although this is not limiting, the examples shown are translators 1 of the “SpeakWorld®” type, substantially as described in document FR 2 921 735.

In order to use a voice translator 1, it is necessary for at least two users 2 (or “wearers”, or indeed “speakers”), one of them being direct and wearing the translator, and the other being indirect and not necessarily wearing his or her own translator 1, but possibly also being fitted with one.

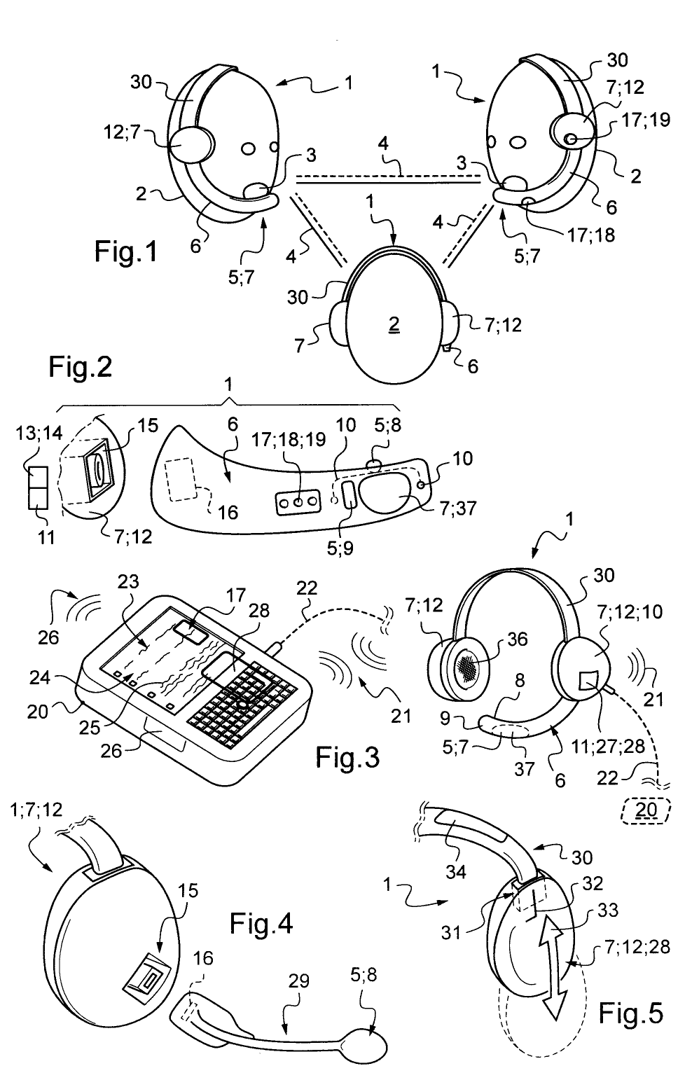

Below, at any given instant, the direct speaker 2 is referred to as the “main” user 2. The other speaker 2, who may optionally be a wearer, is referred to as the “secondary” speaker 2. Naturally, the invention making use of one (or more) “SpeakWorld®” voice translators 1, may also be useful for a group of speakers 2 (see FIG. 1) comprising more than two people who seek to converse. In FIG. 1, there can be seen three users 2 each with a respective translator 1.

A direction 4 is drawn between the positions of the mouths 3 of the main and secondary speakers 2 at any given instant. This direction 4 is referred to as the “conversation axis” (and is drawn as a continuous line together with a dashed line).

In the invention, it has been found useful and agreeable for the speakers 2 to improve sound pickup of the verbal (voice) utterances of the main user 2.

Two main types of sound pickup are known (cf.: http://fr.wikipedia.org/wiki/Microphone#La_directivit.C3.A9) that vary in terms of extent:

pickup devices 5 having a “broad” pickup field (e.g. cardiod microphones); and

pickup devices 5 having a highly directional pickup field (e.g. hypercardiod or shotgun microphones).

It is also known that the “SpeakWorld®” translator 1 according to document FR 2 921 735 possesses a front boom 6 carrying, close to the mouth position of the speaker 2 on the conversation axis 4, a sound playback device 7 (loudspeaker) facing away from the speaker 2 along the direction 4, and in general at least two devices 5 for picking up the voice utterances of the main and secondary speakers 2.

According to the invention, a translator 1 possesses at least two pickup devices 5, e.g. on a single boom 6. One points outwards, i.e. towards the front of the translator 1, and the other points inwards, i.e. towards the rear of the translator 1. Each inward or rearward facing device 5 acts as a mouth microphone 8. Each outward or forward facing device 5 acts as a dialog microphone 9.

In one embodiment, the mouth microphone 8 forms a rearward facing or internal device 5 having a highly directional pickup field (e.g. hypercardiod or shotgun microphones). The dialog microphone 9 forms a (forward facing or external) device 5 having a broad pickup field.

For example, this embodiment is practical for public translations (addresses, conferences, lectures, for example) in which translating the speech (explanations, speeches, etc.) of the wearer 2 of one translator 1 is preponderant, while the positions from which returns (questions, reactions, etc.) originate may be widespread.

In other embodiments, the situation is inverted, and it is the mouth microphone 8 that has a wide pickup field and the dialog microphone 9 that has a highly directional pickup field.

For example, such an embodiment is practical for translations or dialogs taking place in small groups (business negotiations, diplomacy, etc.) where the quality of the translation of the words of one or a few people facing the wearer 2 of a translator 1 are relatively preponderant.

The invention astutely takes advantage of the fact that it is natural for two speakers 2 automatically to face each other while they are conversing. As a result, their mouth positions 3 (and more generally their entire faces, and in particular their eyes and their mouths together) face each other or look at each other so that together they define a conversation axis 4 that is relatively stable, that is shared in common, and that is accurately determined throughout a given stage of conversation.

Under such circumstances, a highly directional speech microphone 9 “aims at” or “points towards” the external speaker, thereby achieving good pickup that is relatively “concentrated” concerning the words of the external speaker (to the detriment of surrounding background noise).

It can thus be understood that one of the pickup devices 5 has a highly directional pickup field (forward looking in this example). When this device 5 faces forwards towards the speaker 2 along the direction 4, the invention thus astutely takes advantage of the mouth positions 3 naturally facing each other in combination with sound being taken over a field of narrow extent so as to “filter” interfering noise from the conversation, so to speak.

Nevertheless, under all circumstances, the naturally facing mouth positions 3 place the sound pickup field automatically so as to be facing relative to the facing mouth 3, thereby ensuring good pickup for the wearer 2. And if this pickup is highly directional, then the interfering noise in the surroundings of the pickup field is recorded little or not at all since it lies outside the field, thereby corresponding to a kind of filtering.

Conversely, when the highly directional pickup field faces rearwards, towards the mouth of the wearer 2 of a translator 1, the invention serves to take advantage of low sensitivity in terms of sound volume picked up by the mouth microphone 8 compared with the greater sensitivity in terms of sound volume picked up by the broad field dialog microphone 9.

Applications of the invention with a rear mouth microphone 8 of highly directional field associated with a front dialog microphone 9 having a broad field may be appropriate, e.g. for dialogs with multiple (three or more) speakers in quiet surroundings where the broad field dialog microphone 9 makes it easier to perceive the speech of each of the parties facing the wearer 2 of a translator 1.

In other embodiments of the invention, a plurality of mouth microphones 8 are provided and a plurality of dialog microphones 9 are also provided, with sound pickup fields of distinct shapes.

Thus, in an embodiment of the invention, at least one mouth microphone 8 has a broad pickup field and another mouth microphone 8 has a very narrow pickup field. In addition, at least one dialog microphone 9 has a broad pickup field and another dialog microphone 9 has a very narrow pickup field.

This can be referred to as a “mixed” pickup system. In one embodiment, electronic and logic means 11 of a mixed translator 1 are used together with means 10 for discriminating sound sources and acting in combination with two rear microphones 8 and two front microphones 9.

For example, the discrimination means 10 evaluate the instantaneous pickup quality from each of the microphones 8-9 and they determine which microphone provides the best rendering of speech. In parallel, the electronic and logic means 11 determine the stage of the current conversation, whose “turn” it is to speak, etc. Under such circumstances, these electronic and logic means 11 select not only whether it is appropriate to process the signal from a rear or front microphone 8 or 9, but also which microphone (broad field or very narrow field) provides the better sound quality for this conversation stage.

When such a mixed translator 1 is economically feasible, this makes it possible to combine both approaches and their advantages.

Depending on the embodiment, at least one very narrow field pickup device 5 is of hypercardiod or shotgun technology. While at least one broad pickup device 5 is of cardiod technology.

The invention thus provides very good pickup sound quality, together with excellent flexibility and positional stability (in proximity and in direction by convergence of the two axes 4), thereby procuring high levels of comfort and mutual understanding for the speakers 2.

In certain embodiments, the device(s) 5, and more precisely the mouth microphone 8 or the dialog microphone 9 possess a respective filter (forming part of the means 11).

For example, it may be a voice training filter such that the voice utterances of two instantaneous speakers 2 are picked up and then stripped of interfering noise and/or acoustically focused on the tones specific to the voice utterances of these two instantaneous speakers 2.

In an embodiment, the mouth and dialog microphones 8 and are the same microphone or two microphones merged in a single device 5, and open ducts (e.g. one open forwards towards the speaker 2 and the other rearwards towards the wearer of the translator 1) form parts of or also form source discrimination means 10.

By way of example, the pickup devices 5 may be microphones produced by the supplier Brüel & Kjaer (cf. http://www.bksv.fr/Products/Transducers/Conditioning/AcousticTransd ucers/Microphones.aspx).

By means of the invention, it is possible to have a translator 1 that is simultaneously compact, lightweight, and modular.

For this purpose, one embodiment provides for all or at least most of the electronic and logic means 11 of a translator 1 to be incorporated in a main earpiece 12.

The term “electronic and logic means” 11 is used to designate the electronic cards and the information processing components, sound signal producing components (including any filters, e.g. for sound focusing), electrical power supply components, connections for connecting accessories to the main earpiece 12, and components for making external connections.

Thus, electronic and logic means 11 serve in embodiments of the invention to provide the translator 1 with external connectivity to other electronic appliances, e.g. a personal digital assistant (PDA), a computer, a wireless network such as WiFi, Bluetooth, 3G, GSM, and a radio frequency identity (RFID) tag, etc., or a wired connection using a USB, FireWire, RS232, mono/stereo jack, etc. connector.

These electronic and logic means 11 are incorporated in the main earpiece 12 in the embodiment shown. However that is naturally not true for accessories (that are potentially removable) such as pickup devices 5 (microphones) and playback devices 7 (loudspeakers), and/or discrimination means 10 (discrimination channels), some of which are offset at a distance from the main earpiece 12.

In the embodiment of FIG. 2, there can be seen a male plug 15 of a USB or FireWire connector that is mounted on the main earpiece 12. The boom 6, which is removable in this example, has a complementary female socket 16 for the USB or FireWire plug.

Naturally, the electronic and logic means 11 include at least one memory 13 for storing data (a read only memory (ROM), a random access memory (RAM), an electrically programmable ROM (EPROM), etc.) that is arranged so as to be capable of storing the various computer programs 14 or software (for managing the hardware of the translator 1, translating, filtering, etc.).

Thus, in an embodiment, the translator 1 possesses a function referred to as “automatic language switching”.

In brief, the sound signals that are picked up, if any (silence) by the device 5 of the mouth microphone type 8, and the sound signals that are picked up, if any (silence) by the other device 5 of the dialog microphone type 9, are logically connected (typically within electronic and logic means 11 incorporated in the main earpiece 12) in order to act at each given instant in order to determine the current stage of a conversation between speakers 2.

The logic processing performed by these means 11 (including discrimination software 14) for the purposes of this “automatic language switching” function, consists in determining automatically, and at each instant—in real time and/or over repeated intervals—which one of the speakers 2 (the speaker who is wearing the translator 1 in question or the other translator 1) is speaking and which one is listening, in particular.

Typically, if a significant signal of a voice utterance is perceived by the device 5 of the highly directional mouth microphone type 8, functions specific to this so-called “delivery” state or stage are put into place.

For example, in the delivery state, the playback of signals coming from the other device 5 of the dialog microphone type 9 is reduced and that of the device 5 of the mouth microphone type 8 is increased, and the translation processing is determined automatically, including selecting the language perceived by the translator 1 and the language to be delivered via the sound playback device 7 on the boom 6.

The corresponding filtering is naturally implemented (by the means 10 and 11 in particular) in order to facilitate mutual comprehension by the speakers 2 using this translator 1.

Conversely, a “listening” state or stage may provide for example that the playback of signals coming from a device 5 of the mouth microphone type 8 is reduced while the playback of signals coming from another device 5 of the dialog microphone type 9 is increased.

The translation processing including the choice of the language produced and interpreted by the translator 1 and the language to be delivered via the devices 7 including the main earpiece 12 is then automatically determined.

Thus, one embodiment makes provision in the delivery state for the language perceived or spoken by the wearer 2 to be French and the language into which it is translated to be English, while the translator 1 switches or is maintained automatically in a “voice utterance translation” mode (e.g. Chinese to German).

On perceiving silence (of relatively long duration and marked in terms of sound volume) by means of the device 5 of the mouth microphone type 8, the translator 1 switches stage, e.g. to the “listening” state, e.g. after validating significant pickup via the other device 5 of the dialog microphone type 9, and the logic processing is placed in a “translate external speech” mode (e.g. German to Chinese).

In FIG. 1, it can be seen that the translator 1 possesses display means 17 for displaying the delivery/listening state.

In this embodiment, firstly the means 17 possess a slab of green light-emitting diodes (LEDs) 18 on the boom 6 close to the devices 5 and 7, i.e. on the outer face of the boom 6. Secondly, the means 17 possess another slab of red LEDs 19 on the main earpiece 12, here close to the devices 5 and 7 of the earpiece 12.

In FIG. 2, it can be seen that the translator 1 possesses another “unitary” form for the delivery/listening state display means 17. In this embodiment, these means 17 possess a single slab of LEDs 18-19 that emit in various colors (depending on the power supply voltage and/or frequency) all grouped together on the boom 6 and also close to the devices 5 and 7 of the outer face.

This group of means 17 is controlled by the means 10 in such a manner that the slab(s) of LEDs 18-19 lights up with a color that is determined as a function of the determined state or stage of the translator 1. Another color, that is clearly distinct visually, is provided for another state or stage. In this example, the slab of LEDs 18-19 lights up in green for the listening state of the wearer 2, and in red for the delivery state of said wearer 2.

The speaker 2 facing the wearer 2 of a translator 1 in the delivery state (red color) thus sees that it is preferable to be silent and listen while the wearer 2 is speaking. Conversely, the same speaker can see that it is possible to speak when the translator 1 shines a green light, indicating that the wearer 2 is in the listening state. This avoids overlaps between verbal deliveries, facilitates processing, and improves the quality of the conversation.

In FIG. 3, it can be seen that the translator 1 is coupled to an electronic appliance 20, e.g. a PDA, a computer, a wireless network such as WiFi, BlueTooth, 3G, GSM, RFID, etc. This appliance 20 is connected via a logical connection 21 which may be of the wired type (e.g. via a cable 22 associated with two jack plugs having a diameter of 1.5 mm).

It can also be seen that the appliance 20 possesses display means 23. This is conventional for PCs, PDAs, Ipod®/Iphone®, BlackBerry®, and other appliances 20 of the Psion®, Archos®, Android® types, in particular.

By using the connection 21, various functions can be off-loaded to means of the appliance 20 that are remote from the translator 1, e.g. that are remote from its main earpiece 12 (which may nevertheless host some or all of the other functions that are not sufficient to the boom 6).

In an embodiment, the display means 17 of the translator 1 are incorporated in the display means 23 of the appliance 20.

In an embodiment, transcription means 24 are incorporated in the display means 23.

Typically, these means 24 are used for a written display of:

a glossary;

interactive lexical proposals (based on voice recognition and/or making a written choice 25 available, e.g. to select between quasi-homonyms);

dictionaries;

transcriptions of conversations (e.g. transferable to a computer, e.g. by email or chat, or to a word processor); and

help in operating the translator 1 (multilingual manual), etc.

An example of transcription means 24 is ViaVoice® or Dragon®.

In an embodiment (FIG. 3), written text reader means 26 are incorporated and/or accessible via the appliance 20. Thereafter, via the connection 21 and/or 22, a reading of the written text produced by or via the appliance 20 is sent orally to the translator 1 (e.g. to the main earpiece 12). Thus, a written text is read and uttered by the translator 1.

In FIG. 2, it should be observed that the means 7 possess a dialog loudspeaker 37. In FIG. 3, the means 7 also posses a listening loudspeaker 36.

The electronic and logic means 11 (including in particular a translation module 27 (FIG. 3)) then operates for the attention of the wearer 2 wearing the translator 1, delivering a voice translation of the written text in the listening language of the wearer 2 (e.g. selected in advance via a control interface 28 of the translator 1, which interface may be on the translator and/or offset on the appliance 20).

Typically, the control interface 28 is touch sensitive (screen, buttons, . . . ), but other control means (e.g. voice control means) could be provided in embodiments, in particular when the risk of interference with speech for translation is limited.

Depending on the embodiments, the translation module 14 (FIG. 2) includes electronic components and language management programs such as Nuance (http://nuance.fr), Jibbigo (http://jibbigo.com), or the like.

Acting via the control interface 28 and/or with the help of the means 10-11, the invention makes it easy to validate the languages of the dialog, sound clarity, etc.

In the embodiment of FIG. 4, it can be seen that the translator 1 possesses a male connector plug 15, on the main earpiece 12 in this example. The translator 1 may be fitted with a USB socket or the like enabling the translator 1 to be connected thereto for exchanging data, signals, or indeed for electrical recharging.

The translator 1 also possesses an additional connector 16, a female connector in this embodiment, into which it is possible to engage the plug 15. The connector 16 is incorporated with a fine rod 29 that has arranged at its distal end (its end remote from the complementary connector 16) the devices 5 (mouth microphone 8) that make it possible when translation is not desired to use the structures of the translator 1 merely as a headset for listening and/or speaking.

Such a headset is useful with various types of appliance 20, once they are connected together by connections 21 and 22, e.g. a cell phone, a PDA, a music player, a computer, or the like.

In the embodiment of FIG. 4, it can be seen that the translator 1 has a headband 30 that supports at least one earpiece (or that is incorporated therewith).

The headband 30 is mechanically coupled to at least one earpiece 12 by adjustment and retention means 31. Typically these adjustment and retention means 31 comprise a ratcheted sliding connection 32.

In order to adjust the relative position (up/down adjustment and disassembly: see arrow 33), or indeed separation so as to remove one or both earpieces 12 from the translator 1.

In FIG. 3, it can be seen that the translator 1 possesses at least one photovoltaic (solar) sensor referenced 34. In this embodiment, a photovoltaic sensor 34 is on the headband 30.

The translator 1 implements a translation method.

Humans communicate with one another by voice using a plurality of languages. Most countries have at least one official language that is its own and that differs from languages used in other countries.

It is also found in certain countries that people do not communicate with one another by making use of the official language of their country but rather by making use of a local language, sometimes referred to as a “patois”, for example.

Transportation is developing to a great extent and it is becoming easy to travel from one country to another. Likewise, it is found that international trade occupies a large portion of worldwide economic activity. The fields of research and exchanging knowledge are also becoming more and more international and thus more and more polyglot.

As a result, whether in the context of tourism or of professional activities, a first individual is very likely to need to communicate with a second individual in a language that differs from the first individual's mother tongue.

It is also common practice to learn one or more foreign languages at school. Unfortunately, it is not possible in practice to master and speak all existing languages.

1.-14. (canceled)

15. A portable electronic translator forming a headset and comprising at least: a sound pickup device arranged on a front boom designed to place the pickup device facing a mouth position of a wearer;
said front boom being mounted on a main earpiece itself secured to a headband or headset;
the pickup device including firstly at least one mouth microphone arranged towards a posterior face of the front boom, and at least one dialog microphone arranged towards an anterior face of the front boom;
a sound playback device including firstly at least one listening loudspeaker incorporated in said earpiece and a dialog loudspeaker incorporated in the front boom so as to be oriented in a manner that is substantially parallel to the direction forming a conversation axis;
and electronic and logic means being provided in the translator and arranged to pick up, process, playback, and translate speech; the translator being characterized in that the pickup device is coupled to the electronic means; and
at least one dialog microphone is oriented towards a speaker in said direction forming a conversation axis and has a front pickup field that is broad, whereas at least one mouth microphone is oriented in an opposite direction, is directed in the direction defined by the conversation axis, and has a rear field that is highly directional.

16. A translator according to claim 15, wherein the electronic means possess discriminator means for discriminating a current conversation stage, including a stage of utterance by the wearer that implies translating into an opposite language when a signal from said mouth microphone is of sound volume greater than another signal from the dialog microphone.

17. A translator according to claim 15, wherein when an utterance stage of conversation has been determined, the electronic means proceed automatically to translation processing of said signal from said mouth microphone into an opposite language.

18. A translator according to claim 15, wherein the pickup device is arranged with a dialog microphone of the cardiod type, having a broad front pickup field.

19. A translator according to claim 15, wherein the pickup device is arranged with a mouth microphone of the hypercardiod or shotgun type, having a highly directional rear field.

20. A translator according to claim 15, wherein the electronic and logic means are provided at least in part in an earpiece of the translator and are arranged automatically to determine the following stages:
utterance of speech by the wearer in the wearer's own language;
translation of said speech into the opposite language;
the person opposite the wearer listening to said speech translated into that person's own language;
the person opposite the wearer uttering other speech in reply in that person's own language that is not understandable by the wearer;
translating that non-understandable speech into the language of the wearer; and
the wearer listening to said speech translated into the wearer's own language.

21. A translator according to claim 15, wherein the translator possesses at least one photovoltaic sensor.

22. A translator according to claim 21, wherein at least one photovoltaic sensor is on the headband of the translator.

23. A translator according to claim 15, wherein the translator possesses display means for displaying the delivery/listening state; these means being controlled by the electronic means so that a light of a determined color is activated as a function of the current stage of conversation, another color that is clearly distinct visually being provided for at least one other stage of conversation.

24. A translator according to claim 15, wherein the electronic means of the translator possess at least one connection for coupling to an external electronic appliance.

25. A translator according to claim 15, wherein the electronic means of the translator include transcription means that are incorporated in display means.

26. A translator according to claim 15, wherein the translator possesses a male connector plug, e.g. on a main earpiece, and/or a complementary female connector, e.g. on a boom.

27. A translation method making use of at least one translator according to claim 15, wherein logic processing performed by the electronic means provides a function of switching language automatically, with it being determined automatically at all times, in real time and/or by repetitive intervals, which one of the wearer of the translator and the person opposite is the speaker who is speaking and which one is the speaker who is listening.

28. A method according to claim 27, wherein the electronic means are arranged so that in a listening state or stage, provision is made for signals coming from the pickup device of the mouth microphone type to be diminished and for playback of the other pickup device of the dialog microphone type to be increased, and/or for translation processing to be determined automatically, including selecting the language that is being produced and that is to be interpreted by the translator, and selecting the language that is to be delivered via the playback devices.
